(19) United States
(12) Patent Application Publication
(10) Pub. No.: US 2025/0259991 A1
(43) Pub. Date: Aug. 14, 2025

(54) POSITIVE ELECTRODE FOR SECONDARY BATTERY, AND SECONDARY BATTERY

(71) Applicant: MURATA MANUFACTURING CO., LTD., Kyoto (JP)

(72) Inventor: Yuichiro HASHIZUME, Kyoto (JP)

(21) Appl. No.: 19/193,574

(22) Filed: Apr. 29, 2025

Related U.S. Application Data
(63) Continuation of application No. PCT/JP2024/012481, filed on Mar. 27, 2024.

(30) Foreign Application Priority Data
Mar. 30, 2023 (JP) 2023-056277

(51) Int. Cl. H01M 4/136; H01M 4/02; H01M 4/58; H01M 4/62; H01M 10/0525

(52) U.S. Cl. CPC H01M 4/136; H01M 4/5825; H01M 4/622; H01M 4/625; H01M 10/0525; H01M 2004/021; H01M 2004/028

(57) ABSTRACT

A positive electrode for a secondary battery and a secondary battery are provided. The secondary battery includes a positive electrode, a negative electrode, and an electrolytic solution. The positive electrode includes a positive electrode active material layer. The positive electrode active material layer includes positive electrode active material particles, a positive electrode binder, a positive electrode conductor, and a carboxymethyl cellulose salt. The positive electrode active material particles include a phosphoric acid compound having an olivine crystal structure. The positive electrode binder includes an acrylic acid ester polymer. The positive electrode conductor includes carbon black. The positive electrode active material layer has a volume resistivity of greater than or equal to 10 Ω·cm and less than or equal to 100 Ω·cm.

### CROSS REFERENCE TO RELATED APPLICATIONS

The present application is a continuation of International Application No. PCT/JP2024/012481, filed on Mar. 27, 2024, which claims priority to Japanese Patent Application No. 2023-056277, filed on Mar. 30, 2023, the entire contents of which are incorporated herein by reference.

### BACKGROUND

The present technology relates to a positive electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode (a positive electrode for a secondary battery), a negative electrode, and an electrolytic solution. A configuration of the secondary battery has been considered in various ways.

Specifically, a positive electrode mixture layer includes an electrode material, a conductive additive, and a binder, the electrode material includes an electrode active material (a transition metal lithium phosphate compound having an olivine structure) and a carbonaceous film, and a volume resistivity of the positive electrode mixture layer having undergone pressing is 5.0 Ω·cm or less.

### SUMMARY

The present technology relates to a positive electrode for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a positive electrode for a secondary battery, and a secondary battery that each make it possible to achieve a superior battery characteristic.

A positive electrode for a secondary battery according to an embodiment of the present technology includes a positive electrode active material layer. The positive electrode active material layer includes positive electrode active material particles, a positive electrode binder, a positive electrode conductor, and a carboxymethyl cellulose salt. The positive electrode active material particles include a phosphoric acid compound having an olivine crystal structure. The positive electrode binder includes an acrylic acid ester polymer. The positive electrode conductor includes carbon black. The positive electrode active material layer has a volume resistivity of greater than or equal to 10 Ω·cm and less than or equal to 100 Ω·cm.

A secondary battery according to an embodiment of the present technology includes a positive electrode, a negative electrode, and an electrolytic solution. The positive electrode has a configuration similar to that of the positive electrode for a secondary battery according to an embodiment of the present technology described above.

As used herein, the “acrylic acid ester polymer” refers to a homopolymer of an acrylic acid ester, a copolymer of an acrylic acid ester, or both. Details of the acrylic acid ester polymer will be described later.

The “volume resistivity of the positive electrode active material layer” is a physical property value of the positive electrode active material layer to be measured using an electrode resistor. Details of a procedure for measuring the volume resistivity of the positive electrode active material layer will be described later.

According to the positive electrode for a secondary battery of an embodiment of the present technology or the secondary battery of an embodiment of the present technology, the positive electrode active material layer includes the positive electrode active material particles (the phosphoric acid compound having the olivine crystal structure), the positive electrode binder (the acrylic acid ester polymer), the positive electrode conductor (carbon black), and the carboxymethyl cellulose salt, and the volume resistivity of the positive electrode active material layer is greater than or equal to 10 Ω·cm and less than or equal to 100 Ω·cm. Accordingly, it is possible to achieve a superior battery characteristic.

Note that effects of the present technology are not necessarily limited to those described above and may include any of a series of effects in relation to the present technology.

### BRIEF DESCRIPTION OF THE FIGURES

FIG. 1 is a sectional diagram illustrating a configuration of a positive electrode for a secondary battery according to an embodiment of the present technology.

FIG. 2 is a sectional diagram illustrating a configuration of a secondary battery according to an embodiment of the present technology.

FIG. 3 is a sectional diagram illustrating a configuration of a battery device illustrated in FIG. 2.

FIG. 4 is a block diagram illustrating a configuration of an application example of the secondary battery.

FIG. 5 is a sectional diagram illustrating a configuration of a secondary battery for testing.

### DETAILED DESCRIPTION

The present technology is described below in further detail including with reference to the drawings according to an embodiment. The description is given in the following order.

A description is given first of a positive electrode for a secondary battery according to an embodiment of the present technology. The positive electrode for a secondary battery will hereinafter be simply referred to as the “positive electrode”.

The positive electrode to be described here is to be used in a secondary battery, which is an electrochemical device. However, the positive electrode may be used in electrochemical devices other than the secondary battery. Specific examples of the other electrochemical devices include a primary battery and a capacitor.

The positive electrode allows an electrode reactant to be inserted into and extracted from the positive electrode upon an operation of the electrochemical device, i.e., upon what is called an electrode reaction. Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. Upon the electrode reaction, lithium is thus inserted in an ionic state into the positive electrode and extracted in the ionic state from the positive electrode.

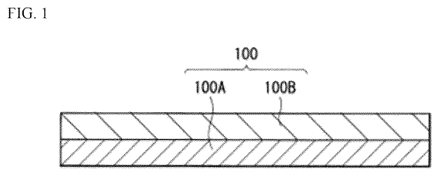

FIG. 1 illustrates a sectional configuration of a positive electrode 100 as a specific example of the positive electrode. As illustrated in FIG. 1, the positive electrode 100 includes a positive electrode current collector 100A and a positive electrode active material layer 100B.

The positive electrode current collector 100A is an electrically conductive support that supports the positive electrode active material layer 100B, and has two opposed surfaces, i.e., an upper surface and a lower surface, on each of which the positive electrode active material layer 100B may be provided. The positive electrode current collector 100A includes an electrically conductive material such as a metal material. Specific examples of the electrically conductive material include aluminum.

However, the positive electrode 100 does not necessarily have to include the positive electrode current collector 100A.

The positive electrode active material layer 100B is a layer that allows lithium to be inserted thereinto and extracted therefrom. The positive electrode active material layer 100B is provided on one of the two opposed surfaces, i.e., either the upper surface or the lower surface, of the positive electrode current collector 100A. However, the positive electrode active material layer 100B may be provided on each of the two opposed surfaces, i.e., the upper surface and the lower surface, of the positive electrode current collector 100A.

The positive electrode active material layer 100B includes a positive electrode active material, a positive electrode binder, a positive electrode conductor, and a carboxymethyl cellulose salt. The positive electrode active material allows lithium to be inserted thereinto and extracted therefrom. The positive electrode active material is in the form of particles, and will hereinafter be referred to as “positive electrode active material particles”.

The positive electrode active material particles are particles that allow lithium to be inserted thereinto and extracted therefrom, and include any one or more of phosphoric acid compounds each having an olivine crystal structure. The phosphoric acid compound having the olivine crystal structure will hereinafter be referred to as an “olivine phosphoric acid compound”.

One reason why the positive electrode active material particles include the olivine phosphoric acid compound is that the olivine phosphoric acid compound is rigid and stable in crystal structure. Release of oxygen from the olivine phosphoric acid compound is thus suppressed. As a result, a stable battery capacity and improved safety are achievable by a secondary battery including the positive electrode 100.

Here, the electrode reactant is lithium as described above, and therefore the olivine phosphoric acid compound includes lithium as a constituent element. In this case, the olivine phosphoric acid compound is not particularly limited in kind, and may be any phosphoric acid compound that includes lithium as its constituent element.

Note that the olivine phosphoric acid compound may further include one or more of metal elements (excluding lithium) as one or more constituent elements. The metal elements are not particularly limited in kind, and specific examples thereof include iron, manganese, cobalt, nickel, titanium, chromium, vanadium, zinc, tin, tungsten, zirconium, magnesium, and aluminum.

The one or more metal elements are preferably iron, in particular. In other words, the olivine phosphoric acid compound preferably includes lithium and iron as constituent elements. One reason for this is that the release of oxygen from the olivine phosphoric acid compound is sufficiently suppressed, which makes it possible to achieve a sufficient battery capacity and sufficiently improved safety.

More specifically, the olivine phosphoric acid compound preferably includes any one or more of compounds represented by Formula (1). Note that when the olivine phosphoric acid compound includes two or more metal elements (Me) as constituent elements, a mixture ratio (molar ratio) between the two or more metal elements may be set as desired.

LiₓMePO₄ (1)
where:
Me is at least one of Fe, Mn, Co, Ni, Ti, Cr, V, Zn, Sn, W, Zr, Mg, or Al; and
x satisfies 0.9≤x≤1.1.

Specific examples of the olivine phosphoric acid compound include LiFePO₄, LiMnPO₄, LiFe_{0.5}Mn_{0.5}PO₄, and LiFe_{0.5}Co_{0.5}PO₄.

Here, the positive electrode active material particles are secondary particles that each include an aggregate of primary particles. The positive electrode active material layer 100B therefore includes the positive electrode active material particles that are the secondary particles. Here, multiple ones of the primary particles gather together into each secondary particle.

It is preferable that the primary particles have a median diameter MD1 of 1 μm or less and the positive electrode active material particles (the secondary particles) have a median diameter MD2 within a range from 4 μm to 20 μm both inclusive. One reason for this is that this makes it easier for the primary particles to be coupled together in the secondary particle, and accordingly makes it easier for the secondary particles also to be coupled together. As a result, electron conductivity between the positive electrode active material particles improves, which allows for improved electrical conductivity of the positive electrode active material layer 100B.

A procedure for calculating the median diameter MD1 is as described below. First, a section of the positive electrode active material layer 100B is observed (at a 10,000-fold magnification for observation) with a scanning electron microscope (SEM). The positive electrode active material particles included in the positive electrode active material layer 100B are thereby observed, and the primary particles included in each positive electrode active material particle are thus observed. Thereafter, any 50 primary particles whose respective outlines (outer edges) are observable are selected from among the primary particles, following which a particle size (a major axis diameter) of each of those primary particles is measured. Lastly, an average value of the 50 particle sizes is calculated to be the median diameter MD1.

To measure the median diameter MD2, the positive electrode active material particles are analyzed with a particle size measurement apparatus. As the particle size measurement apparatus, for example, a laser diffraction/scattering particle size distribution analyzer LA-960 available from HORIBA, Ltd. may be used.

More specifically, to measure the median diameter MD2, first, the positive electrode 100 is put into an aqueous solvent to thereby cause the positive electrode active material layer 100B to peel away from the positive electrode current collector 100A. The aqueous solvent is not particularly limited in kind, and examples thereof include pure water in which the positive electrode binder and the carboxymethyl cellulose salt are dissolvable. Details of the aqueous solvent described here are similarly applicable hereinafter. Thereafter, the positive electrode active material layer 100B is put into an aqueous solvent to stir the aqueous solvent, following which the aqueous solvent is filtered. The positive electrode binder and a dispersant are thereby dissolved and removed, and as a result, solids (the positive electrode active material particles and the positive electrode conductor) are recovered.

Thereafter, the solids are put into an aqueous solvent, following which the solids in the aqueous solvent are centrifuged. This separates the positive electrode active material particles from the positive electrode conductor, thus allowing the positive electrode active material particles to be recovered. Lastly, the positive electrode active material particles are analyzed with the particle size measurement apparatus to thereby measure the median diameter MD2.

The positive electrode binder is a material that binds a material such as the positive electrode active material particles to each other. The positive electrode binder includes a water-soluble polymer compound, more specifically, any one or more of acrylic acid ester polymers. One reason for this is that this secures a binding property to be achieved by the use of the positive electrode binder and suppresses decomposition of the positive electrode binder even at a high potential.

As described above, the acrylic acid ester polymer includes a homopolymer of the acrylic acid ester, a copolymer of the acrylic acid ester, or both. The homopolymer of the acrylic acid ester may be only one kind of homopolymer of the acrylic acid ester, or may include two or more kinds of homopolymers of the acrylic acid ester. The copolymer of the acrylic acid ester may be only one kind of copolymer of the acrylic acid ester, or may include two or more kinds of copolymers of the acrylic acid ester.

The homopolymer of the acrylic acid ester is what is called a polyacrylic acid ester. Specific examples of the polyacrylic acid ester include poly(methyl acrylate), poly(ethyl acrylate), and poly(butyl acrylate).

The copolymer of the acrylic acid ester is a compound in which the acrylic acid ester and one or more monomers (excluding the acrylic acid ester) are copolymerized. Specific examples of the acrylic acid ester include methyl acrylate, ethyl acrylate, and butyl acrylate. The monomers are not particularly limited in kind, and specific examples thereof include acrylonitrile.

Note that the copolymer of the acrylic acid ester may be a binary copolymer in which the acrylic acid ester and one monomer are copolymerized, or may be a ternary copolymer in which the acrylic acid ester and two monomers are copolymerized. Needless to say, the copolymer of the acrylic acid ester may be a quaternary or higher copolymer. A copolymerization amount of the monomer(s) in the copolymer of the acrylic acid ester is not particularly limited, and may be set as desired.

The acrylic acid ester polymer preferably includes a binary copolymer in which the acrylic acid ester and acrylonitrile are copolymerized, in particular. One reason for this is that this sufficiently improves the binding property to be achieved by the use of the positive electrode binder and sufficiently suppresses the decomposition of the positive electrode binder even at a high potential.

A content of the positive electrode binder in the positive electrode active material layer 100B is preferably within a range from 0.5 wt % to 4.0 wt % both inclusive, in particular, although not particularly limited thereto. One reason for this is that this suppresses a decrease in electrical conductivity of the positive electrode 100.

More specifically, if the content of the positive electrode binder in the positive electrode active material layer 100B is less than 0.5 wt %, the binding property of the material such as the positive electrode active material particles to be achieved by the use of the positive electrode binder becomes insufficient. This causes the positive electrode active material layer 100B to collapse and peel away from the positive electrode current collector 100A. As a result, the electrical conductivity of the positive electrode 100 can decrease.

In contrast, if the content of the positive electrode binder in the positive electrode active material layer 100B is greater than 4.0 wt %, a proportion of a low electrical conductivity component (the positive electrode binder) included in the positive electrode active material layer 100B increases, which can basically decrease the electrical conductivity of the positive electrode 100.

A procedure for examining the content of the positive electrode binder in the positive electrode active material layer 100B is as described below.

First, the positive electrode current collector 100A is caused to peel away from the positive electrode active material layer 100B, following which a weight of the positive electrode active material layer 100B is measured. Thereafter, the positive electrode active material layer 100B is analyzed by thermogravimetric analysis (TGA) to thereby calculate a weight of the positive electrode binder included in the positive electrode active material layer 100B. For example, when a thermal decomposition temperature of the positive electrode binder is within a range from about 300° C. to 600° C., the positive electrode active material layer 100B is heated at a temperature raising rate of 1° C./min to thereby calculate the weight of the positive electrode binder, based on a weight loss rate in a heating temperature range from about 300° C. to 600° C. Lastly, the content of the positive electrode binder in the positive electrode active material layer 100B is calculated based on the weight of the positive electrode active material layer 100B and the weight of the positive electrode binder.

The positive electrode conductor is a material that improves the electrical conductivity of the positive electrode active material layer 100B, and includes any one or more kinds of carbon black. One reason for this is that the electrical conductivity of the positive electrode active material layer 100B sufficiently improves. Specific examples of the carbon black include Ketjen black, acetylene black, furnace black, channel black, and thermal black.

The carbon black preferably includes Ketjen black, in particular. One reason for this is that owing to a particle shape thereof, Ketjen black makes it possible to hold a large amount of electrolytic solution in a secondary battery including the positive electrode 100. Further, because Ketjen black has a specific gravity lower than that of, for example, acetylene black, the positive electrode conductor is adsorbable in a large amount on a surface of the positive electrode active material particle. As a result, in the positive electrode active material layer 100B, an extensive electron network (electron conductive path) is formed and lithium ions are allowed to move smoothly.

A content of the positive electrode conductor in the positive electrode active material layer 100B is preferably within a range from 0.5 wt % to 3.0 wt % both inclusive, in particular, although not particularly limited thereto. One reason for this is that this improves temporal stability of a positive electrode mixture slurry in a manufacturing process of the positive electrode 100, and sufficiently improves the electrical conductivity of the positive electrode 100.

More specifically, if the content of the positive electrode conductor in the positive electrode active material layer 100B is less than 0.5 wt %, a proportion of an electrically conductive component (the positive electrode conductor) included in the positive electrode active material layer 100B decreases, which can basically decrease the electrical conductivity of the positive electrode 100.

In contrast, if the content of the positive electrode conductor in the positive electrode active material layer 100B is greater than 3.0 wt %, fluidity of the positive electrode mixture slurry decreases in the manufacturing process of the positive electrode 100, which can result in lower temporal stability of the positive electrode mixture slurry.

A procedure for examining the content of the positive electrode conductor in the positive electrode active material layer 100B is as described below.

First, the positive electrode current collector 100A is caused to peel away from the positive electrode active material layer 100B, following which the weight of the positive electrode active material layer 100B is measured.

Thereafter, the positive electrode active material layer 100B is immersed in an organic solvent to thereby dissolve the positive electrode binder included in the positive electrode active material layer 100B. Specific examples of the organic solvent include any one or more of solvents including, without limitation, N-methyl-2-pyrrolidone, dimethylformamide, and dimethylsulfoxide. Thereafter, dissolved matter is filtered to thereby recover a residue, following which the residue is dried.

Thereafter, the residue is immersed in an aqueous solvent to thereby dissolve the carboxymethyl cellulose salt included in the residue. Thereafter, a residue is filtered to thereby recover the residue, following which the residue is dried.

Thereafter, the residue is subjected to carbon analysis to thereby calculate a weight of a carbon component (the positive electrode conductor) included in the residue. As an analyzer for the carbon analysis, for example, a carbon-sulfur analyzer (a CS meter) EMIA-920V2 available from HORIBA, Ltd. may be used.

Lastly, the content of the positive electrode conductor in the positive electrode active material layer 100B is calculated based on the weight of the positive electrode active material layer 100B and the weight of the positive electrode conductor.

The carboxymethyl cellulose salt is a material that improves dispersibility of a material such as the positive electrode active material particles by appropriately increasing a viscosity of the positive electrode mixture slurry when the positive electrode mixture slurry is prepared in the manufacturing process of the positive electrode 100. That is, the carboxymethyl cellulose salt is what is called a thickener.

The carboxymethyl cellulose salt includes any one or more of water-soluble carboxymethyl cellulose salts. One reason for this is that this improves the dispersibility of the material such as the positive electrode active material particles while securing the fluidity of the positive electrode mixture slurry.

The carboxymethyl cellulose salt is not particularly limited in kind, and specific examples thereof include a carboxymethyl cellulose alkali metal salt and a carboxymethyl cellulose alkaline earth metal salt. Specific examples of the carboxymethyl cellulose alkali metal salt include lithium carboxymethyl cellulose, sodium carboxymethyl cellulose, and potassium carboxymethyl cellulose. Specific examples of the carboxymethyl cellulose alkaline earth metal salt include magnesium carboxymethyl cellulose and calcium carboxymethyl cellulose.

The carboxymethyl cellulose salt preferably includes sodium carboxymethyl cellulose, in particular. One reason for this is that the fluidity of the positive electrode mixture slurry sufficiently improves and the dispersibility of the material such as the positive electrode active material particles also sufficiently improves.

A content of the carboxymethyl cellulose salt in the positive electrode active material layer 100B is preferably within a range from 0.6 wt % to 2.0 wt % both inclusive, in particular, although not particularly limited thereto. One reason for this is that this improves the temporal stability of the positive electrode mixture slurry in the manufacturing process of the positive electrode 100, and improves physical durability of the positive electrode active material layer 100B to be formed using the positive electrode mixture slurry.

More specifically, if the content of the carboxymethyl cellulose salt in the positive electrode active material layer 100B is less than 0.6 wt %, the fluidity of the positive electrode mixture slurry decreases in the manufacturing process of the positive electrode 100, which can result in lower temporal stability of the positive electrode mixture slurry.

In contrast, if the content of the carboxymethyl cellulose salt in the positive electrode active material layer 100B is greater than 2.0 wt %, the positive electrode active material layer 100B formed using the positive electrode mixture slurry becomes excessively hard, which can result in lower physical durability of the positive electrode active material layer 100B. In such a case, the positive electrode active material layer 100B can become cracked, and can also become detached from the positive electrode current collector 100A.

A procedure for examining the content of the carboxymethyl cellulose salt in the positive electrode active material layer 100B is as described below.

First, the positive electrode current collector 100A is caused to peel away from the positive electrode active material layer 100B, following which the weight of the positive electrode active material layer 100B is measured. Thereafter, the positive electrode active material layer 100B is analyzed by the thermogravimetric analysis in a nitrogen atmosphere to thereby calculate a weight of the carboxymethyl cellulose salt included in the positive electrode active material layer 100B. For example, when a thermal decomposition temperature of the carboxymethyl cellulose salt is about 250° C., the positive electrode active material layer 100B is heated at a temperature raising rate of 1° C./min to thereby calculate the weight of the carboxymethyl cellulose salt, based on the weight loss rate in a heating temperature range from room temperature to about 250° C. Lastly, the content of the carboxymethyl cellulose salt in the positive electrode active material layer 100B is calculated based on the weight of the positive electrode active material layer 100B and the weight of the carboxymethyl cellulose salt.

The positive electrode active material layer 100B has a volume resistivity R within a range from 10 Ω·cm to 100 Ω·cm both inclusive. One reason for this is that this allows an appropriate electron network including the positive electrode active material particles and the positive electrode conductor to be formed in the positive electrode active material layer 100B, and thus improves the electrical conductivity of the positive electrode active material layer 100B.

More specifically, if the volume resistivity R is less than 10 Ω·cm, particles of the positive electrode conductor are easily coupled to each other with hardly any positive electrode active material particles interposed therebetween in the positive electrode active material layer 100B. Accordingly, an electron network is easily formed by the positive electrode conductor alone, independently of the positive electrode active material particles. In this case, it is difficult to form an appropriate electron network including the positive electrode active material particles and the positive electrode conductor, and it is thus difficult to allow electrons to be sufficiently conducted to each positive electrode active material particle. This increases electric resistance in the positive electrode active material layer 100B, resulting in a decrease in electrical conductivity of the positive electrode active material layer 100B.

In contrast, if the volume resistivity R is greater than 100 Ω·cm, the electric resistance excessively increases in the positive electrode active material layer 100B, which basically decreases the electrical conductivity of the positive electrode active material layer 100B.

The volume resistivity R is to be measured using an electrode resistor, as described above. As the electrode resistor, an electrode resistance measurement system RM2610 available from Hioki E. E. Corporation may be used. In this case, the volume resistivity R of the positive electrode active material layer 100B is measured by analyzing the positive electrode 100 using the electrode resistor.

In the positive electrode 100, upon the electrode reaction, lithium is extracted in the ionic state from the positive electrode active material layer 100B, and is inserted in the ionic state into the positive electrode active material layer 100B.

The positive electrode 100 is manufactured by the following example procedure.

First, the carboxymethyl cellulose salt, the positive electrode conductor in powder form, and an aqueous solvent are mixed with each other to obtain a first mixture liquid, following which the first mixture liquid is stirred (i.e., preliminary kneading is performed). In this case, the preliminary kneading is performed until the positive electrode conductor swells.

The aqueous solvent is not particularly limited in kind, and specific examples thereof include pure water. Details of the aqueous solvent described here are similarly applicable hereinafter. Note that a stirring apparatus such as a planetary mixer may be used to stir the first mixture liquid.

When stirring the first mixture liquid, a solids concentration of the first mixture liquid is set to be higher than a solids concentration of the positive electrode mixture slurry to be prepared in a later process. The first mixture liquid is thus stirred in a state where the solids concentration is intentionally increased. The solids concentration of the first mixture liquid is specifically set to be higher than the solids concentration of the positive electrode mixture slurry by about 5% to 15%, although not particularly limited thereto. In this case, the first mixture liquid is continuously stirred until no aggregates are present in the first mixture liquid.

One reason for stirring the first mixture liquid in the state where the solids concentration is intentionally increased is to cause the positive electrode conductor to be sufficiently dispersed in the positive electrode mixture slurry to thereby improve the electrical conductivity of the positive electrode active material layer 100B to be formed using the positive electrode mixture slurry.

More specifically, the positive electrode conductor is hydrophobic and therefore has a property of being less dispersible in the first mixture liquid that includes the aqueous solvent. If the positive electrode conductor is not sufficiently dispersed in the first mixture liquid, it becomes difficult to form the appropriate electron network including the positive electrode active material particles and the positive electrode conductor in the positive electrode active material layer 100B, which results in lower electrical conductivity of the positive electrode active material layer 100B.

However, if the first mixture liquid is stirred in the state where the solids concentration is intentionally increased, it becomes easier for the carboxymethyl cellulose salt to cover a surface of the positive electrode conductor, and therefore it becomes easier for the positive electrode conductor to be dispersed in the first mixture liquid including the aqueous solvent. As a result, the electron network including the positive electrode active material particles and the positive electrode conductor is easily formed in the positive electrode active material layer 100B, which improves the electrical conductivity of the positive electrode active material layer 100B.

Thereafter, the positive electrode active material particles and an aqueous solvent are added to the first mixture liquid to thereby obtain a second mixture liquid, following which the second mixture liquid is stirred (i.e., main kneading is performed). Note that a stirring apparatus may be used to stir the second mixture liquid, as with when stirring the first mixture liquid.

When stirring the second mixture liquid, a solids concentration of the second mixture liquid is set to be higher than the solids concentration of the positive electrode mixture slurry to thereby stir the second mixture liquid in a state where the solids concentration is intentionally increased, as with when stirring the first mixture liquid. Details of the solids concentration of the second mixture liquid are similar to those of the solids concentration of the first mixture liquid. In this case, the second mixture liquid is continuously stirred until no aggregates are present in the second mixture liquid.

One reason for stirring the second mixture liquid in the state where the solids concentration is intentionally increased is to cause the positive electrode active material particles to be sufficiently dispersed in the positive electrode mixture slurry to thereby improve the electrical conductivity of the positive electrode active material layer 100B to be formed using the positive electrode mixture slurry.

More specifically, the positive electrode active material particles are hydrophobic and therefore have a property of being less dispersible in the second mixture liquid that includes the aqueous solvent. Accordingly, it is difficult to form the appropriate electron network including the positive electrode active material particles and the positive electrode conductor in the positive electrode active material layer 100B, which results in lower electrical conductivity of the positive electrode active material layer 100B.

However, if the second mixture liquid is stirred in the state where the solids concentration is intentionally increased, it becomes easier for the carboxymethyl cellulose salt to cover respective surfaces of the positive electrode active material particles, and therefore it becomes easier for the positive electrode active material particles to be dispersed in the second mixture liquid including the aqueous solvent. As a result, the electron network including the positive electrode active material particles and the positive electrode conductor is easily formed in the positive electrode active material layer 100B, which improves the electrical conductivity of the positive electrode active material layer 100B.

After the second mixture liquid is stirred, the positive electrode binder and an aqueous solvent are added to the second mixture liquid to thereby stir the second mixture liquid. As a result, the positive electrode active material particles and the positive electrode conductor are dispersed in the second mixture liquid and the positive electrode binder is dissolved in the second mixture liquid. Thus, the positive electrode mixture slurry is prepared. Note that the stirring apparatus may be used to stir the second mixture liquid, as described above.

In this case, to add the positive electrode binder to the second mixture liquid, a dispersion liquid (emulsion liquid) in which the positive electrode binder is dispersed in advance may be used. One reason for this is that this improves dispersibility of the positive electrode binder in the positive electrode mixture slurry.

Lastly, the positive electrode mixture slurry is applied on one of the two opposed surfaces of the positive electrode current collector 100A to thereby form the positive electrode active material layer 100B. Thereafter, the positive electrode active material layer 100B may be compression-molded by a molding machine such as a roll pressing machine. In this case, the positive electrode active material layer 100B may be heated. The positive electrode active material layer 100B may be compression-molded multiple times.

The positive electrode active material layer 100B is thus formed on the one of the two opposed surfaces of the positive electrode current collector 100A. As a result, the positive electrode 100 is completed.

In the positive electrode 100, the positive electrode active material layer 100B includes the positive electrode active material particles (the olivine phosphoric acid compound), the positive electrode binder (the acrylic acid ester polymer), the positive electrode conductor (carbon black), and the carboxymethyl cellulose salt. Further, the positive electrode active material layer 100B has the volume resistivity R within the range from 10 Ω·cm to 100 Ω·cm both inclusive.

In this case, the volume resistivity R is made appropriate in the positive electrode active material layer 100B including the positive electrode active material particles (the olivine phosphoric acid compound), the positive electrode binder (the acrylic acid ester polymer), the positive electrode conductor (carbon black), and the carboxymethyl cellulose salt. As a result, as described above, the appropriate electron network including the positive electrode active material particles and the positive electrode conductor is formed in the positive electrode active material layer 100B.

Accordingly, the electrical conductivity of the positive electrode active material layer 100B improves. This makes it possible to achieve a superior battery characteristic.

The carbon black may include Ketjen black, in particular. This allows an extensive electron network to be formed in the positive electrode active material layer 100B and allows lithium ions to move smoothly. Accordingly, it is possible to achieve higher effects.

Further, the content of the positive electrode conductor in the positive electrode active material layer 100B may be within the range from 0.5 wt % to 3.0 wt % both inclusive. This improves the temporal stability of the positive electrode mixture slurry in the manufacturing process of the positive electrode 100, and sufficiently improves the electrical conductivity of the positive electrode 100. Accordingly, it is possible to achieve higher effects.

Further, the olivine phosphoric acid compound may include lithium and iron as the constituent elements. This sufficiently suppresses the release of oxygen from the olivine phosphoric acid compound. Accordingly, a sufficient battery capacity and sufficiently improved safety are achievable. It is thus possible to achieve higher effects.

Further, the acrylic acid ester polymer may include a copolymer of the acrylic acid ester and acrylonitrile. This sufficiently improves the binding property to be achieved by the use of the positive electrode binder, and sufficiently suppresses the decomposition of the positive electrode binder even at a high potential. Accordingly, it is possible to achieve higher effects.

Further, the content of the positive electrode binder in the positive electrode active material layer 100B may be within the range from 0.5 wt % to 4.0 wt % both inclusive. This suppresses a decrease in electrical conductivity of the positive electrode 100. Accordingly, it is possible to achieve higher effects.

The carboxymethyl cellulose salt may include sodium carboxymethyl cellulose. This sufficiently improves the fluidity of the positive electrode mixture slurry, and also sufficiently improves the dispersibility of the material such as the positive electrode active material particles. Accordingly, it is possible to achieve higher effects.

Further, the content of the carboxymethyl cellulose salt in the positive electrode active material layer 100B may be within the range from 0.6 wt % to 2.0 wt % both inclusive. This improves the temporal stability of the positive electrode mixture slurry in the manufacturing process of the positive electrode 100, and sufficiently improves the physical durability of the positive electrode active material layer 100B to be formed using the positive electrode mixture slurry. Accordingly, it is possible to achieve higher effects.

Further, the median diameter MD1 may be 1 μm or less and the median diameter MD2 may be within the range from 4 μm to 20 μm both inclusive. This improves the electron conductivity between the positive electrode active material particles. Accordingly, it is possible to achieve higher effects.

A description is given next of a secondary battery according to an embodiment of the present technology to which the positive electrode 100 is to be applied.

The secondary battery to be described here is a secondary battery in which a battery capacity is obtained through insertion and extraction of an electrode reactant, and includes a positive electrode, a negative electrode, and an electrolytic solution. Examples are given below of the case where the electrode reactant is lithium, as in the description given above. A secondary battery in which the battery capacity is obtained through insertion and extraction of lithium is what is called a lithium-ion secondary battery. In the lithium-ion secondary battery, lithium is inserted and extracted in the ionic state.

A charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of the electrode reactant on a surface of the negative electrode during charging.

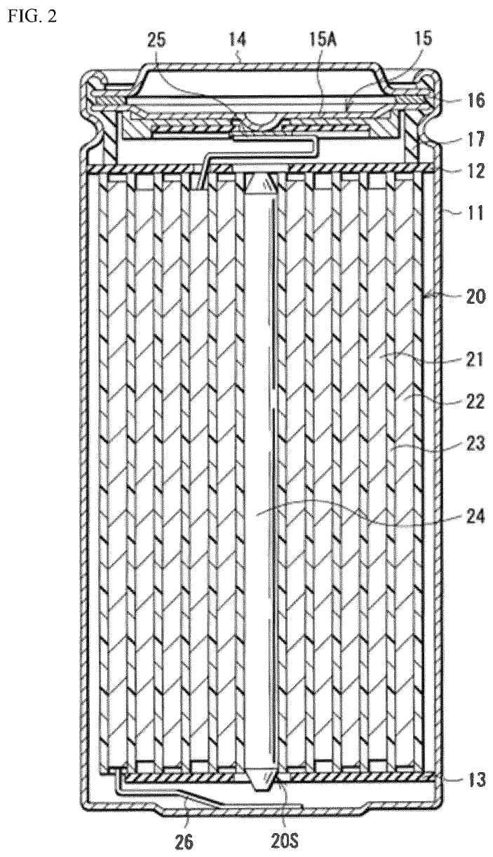

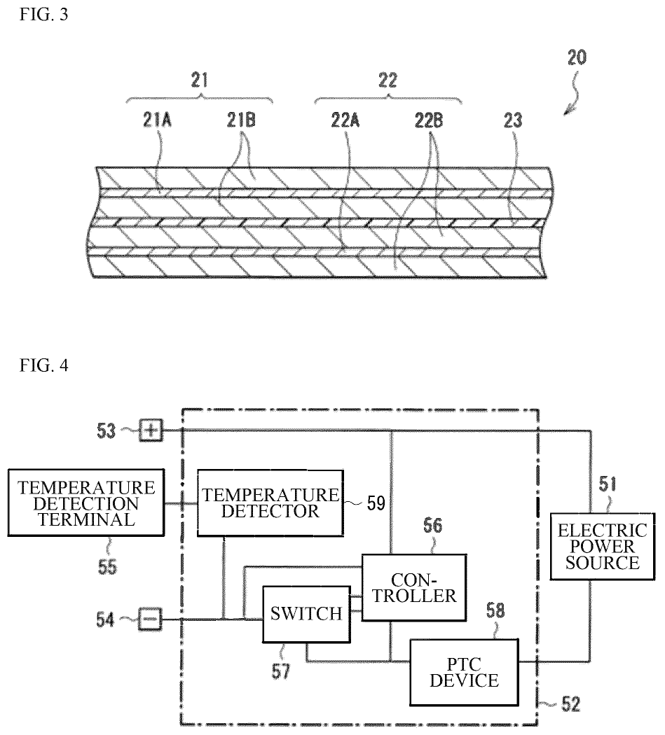

FIG. 2 illustrates a sectional configuration of the secondary battery. FIG. 3 illustrates a sectional configuration of a battery device 20 illustrated in FIG. 2.

As illustrated in FIGS. 2 and 3, the secondary battery includes a battery can 11, a pair of insulating plates 12 and 13, the battery device 20, a positive electrode lead 25, and a negative electrode lead 26. The secondary battery described here is a secondary battery of a cylindrical type in which the battery device 20 is contained in the battery can 11 having a cylindrical shape.

The battery can 11 is a container member that contains the battery device 20 and other components. The battery can 11 has one end part that is open and another end part that is closed, and thus has a hollow structure. Further, the battery can 11 includes any one or more of metal materials including, without limitation, iron, aluminum, an iron alloy, and an aluminum alloy. Note that the battery can 11 may have a surface plated with a metal material such as nickel.

A battery cover 14, a safety valve mechanism 15, and a PTC device 16, which is a thermosensitive resistive device, are crimped at the open end part of the battery can 11 via a gasket 17. The battery can 11 is thus sealed by the battery cover 14. Here, the battery cover 14 includes a material similar to the material included in the battery can 11. The safety valve mechanism 15 and the PTC device 16 are provided on an inner side of the battery cover 14. The safety valve mechanism 15 is electrically coupled to the battery cover 14 with the PTC device 16 interposed therebetween. The gasket 17 includes an insulating material. The gasket 17 may have a surface coated with a material such as asphalt.

When an internal pressure of the battery can 11 reaches a certain level or higher as a result of a cause such as an internal short circuit or heating from outside, a disk plate 15A in the safety valve mechanism 15 inverts, thereby cutting off electrical coupling between the battery cover 14 and the battery device 20. To prevent abnormal heat generation resulting from a large current, an electric resistance of the PTC device 16 increases with a rise in temperature.

The insulating plates 12 and 13 are so disposed as to be opposed to each other with the battery device 20 interposed therebetween. The battery device 20 is thus sandwiched between the insulating plates 12 and 13.

The battery device 20 is what is called a power generation device, and includes a positive electrode 21, a negative electrode 22, a separator 23, and an electrolytic solution (not illustrated).

The battery device 20 is what is called a wound electrode body. Thus, the positive electrode 21 and the negative electrode 22 are opposed to each other with the separator 23 interposed therebetween and are wound. A center pin 24 is disposed in a space 20S provided at a winding center of the battery device 20. However, the center pin 24 may be omitted.

The positive electrode 21 has a configuration similar to the configuration of the positive electrode 100.

Specifically, the positive electrode 21 includes a positive electrode current collector 21A and a positive electrode active material layer 21B. The positive electrode current collector 21A has a configuration similar to that of the positive electrode current collector 100A. The positive electrode active material layer 21B has a configuration similar to that of the positive electrode active material layer 100B. Here, the positive electrode active material layer 21B is provided on each of two opposed surfaces of the positive electrode current collector 21A.

The negative electrode 22 includes a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials that each allow lithium to be inserted thereinto and extracted therefrom. Note that the negative electrode active material layer 22B may further include any one or more of other materials including, without limitation, a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material and a metal-based material. One reason for this is that this allows for a high energy density.

Specific examples of the carbon material include graphitizable carbon, non-graphitizable carbon, and graphite (natural graphite and artificial graphite).

The metal-based material is a material that includes, as one or more constituent elements, any one or more elements among metal elements and metalloid elements that are each able to form an alloy with lithium. Specific examples of the metal elements and the metalloid elements include silicon and tin. The metal-based material may be a simple substance, an alloy, a compound, a mixture of two or more thereof, or a material including two or more phases thereof. Note that the simple substance may contain any amount of impurity. Accordingly, purity of the simple substance does not necessarily have to be 100%. Specific examples of the metal-based material include TiSi₂ and SiOₓ (where 0<x≤2 or 0.2<x<1.4).

The negative electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The negative electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The separator 23 is an insulating porous film interposed between the positive electrode 21 and the negative electrode 22, and allows a lithium ion to pass therethrough while preventing a short circuit caused by contact between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

The solvent includes any one or more of non-aqueous solvents (organic solvents). The electrolytic solution including the one or more non-aqueous solvents is what is called a non-aqueous electrolytic solution.

Examples of the non-aqueous solvents include esters and ethers, and more specific examples thereof include a carbonic-acid-ester-based compound, a carboxylic-acid-ester-based compound, and a lactone-based compound. One reason for this is that a dissociation property of the electrolyte salt and mobility of ions improve.

The carbonic-acid-ester-based compound is a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ethers may include 1,2-dimethoxy ethane, tetrahydrofuran, 1,3-dioxolane, and 1,4-dioxane.

Further, the non-aqueous solvents include an unsaturated cyclic carbonic acid ester, a fluorinated cyclic carbonic acid ester, a sulfonic acid ester, a phosphoric acid ester, an acid anhydride, a nitrile compound, and an isocyanate compound. One reason for this is that the electrolytic solution improves in electrochemical stability.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl) methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is specifically within a range from 0.3 mol/kg to 3.0 mol/kg both inclusive with respect to the solvent, although not particularly limited thereto. One reason for this is that high ion conductivity is obtainable.

The positive electrode lead 25 is coupled to the positive electrode current collector 21A, and includes an electrically conductive material such as aluminum. The positive electrode lead 25 is electrically coupled to the battery cover 14 with the safety valve mechanism 15 interposed therebetween.

The negative electrode lead 26 is coupled to the negative electrode current collector 22A, and includes an electrically conductive material such as nickel. The negative electrode lead 26 is electrically coupled to the battery can 11.

The secondary battery operates as described below upon charging and discharging.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon each of the charging and the discharging, lithium is inserted and extracted in the ionic state.

To manufacture the secondary battery, the positive electrode 21 and the negative electrode 22 are fabricated and the electrolytic solution is prepared, following which the secondary battery is assembled, and the assembled secondary battery is subjected to a stabilization process, in accordance with an example procedure described below.

The positive electrode 21 is fabricated by forming the positive electrode active material layers 21B on the two respective opposed surfaces of the positive electrode current collector 21A by a procedure similar to the fabrication procedure of the positive electrode 100 described above.

First, a mixture (a negative electrode mixture) in which the negative electrode active material, the negative electrode binder, and the negative electrode conductor are mixed with each other is put into a solvent to thereby prepare a negative electrode mixture slurry in paste form. The solvent may be an aqueous solvent, or may be an organic solvent. Thereafter, the negative electrode mixture slurry is applied on the two opposed surfaces of the negative electrode current collector 22A to thereby form the negative electrode active material layers 22B. Lastly, the negative electrode active material layers 22B may be compression-molded by a machine such as a roll pressing machine. In this case, the negative electrode active material layers 22B may be heated. The negative electrode active material layers 22B may be compression-molded multiple times. The negative electrode active material layers 22B are thus formed on the two respective opposed surfaces of the negative electrode current collector 22A. As a result, the negative electrode 22 is fabricated.

The electrolyte salt is put into the solvent. The electrolyte salt is thereby dispersed or dissolved in the solvent. As a result, the electrolytic solution is prepared.

First, the positive electrode lead 25 is coupled to the positive electrode current collector 21A by a joining method such as a welding method, and the negative electrode lead 26 is coupled to the negative electrode current collector 22A of the negative electrode 22 by the joining method such as the welding method. Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated) having the space 20S. The wound body has a configuration similar to that of the battery device 20 except that the positive electrode 21, the negative electrode 22, and the separator 23 are each not impregnated with the electrolytic solution. Thereafter, the center pin 24 is placed into the space 20S of the wound body.

Thereafter, with the wound body being sandwiched between the insulating plates 12 and 13, the wound body and the insulating plates 12 and 13 are placed into the battery can 11. In this case, the positive electrode lead 25 is coupled to the safety valve mechanism 15 by a joining method such as a welding method, and the negative electrode lead 26 is coupled to the battery can 11 by the joining method such as the welding method. Thereafter, the electrolytic solution is injected into the battery can 11 to thereby impregnate the wound body with the electrolytic solution. Thus, the positive electrode 21, the negative electrode 22, and the separator 23 are impregnated with the electrolytic solution. As a result, the battery device 20 is fabricated.

Lastly, the battery cover 14, the safety valve mechanism 15, and the PTC device 16 are placed into the battery can 11, following which the battery can 11 is crimped via the gasket 17. Thus, the battery cover 14, the safety valve mechanism 15, and the PTC device 16 are fixed to the battery can 11, and the battery device 20 is sealed in the battery can 11. As a result, the secondary battery is assembled.

The secondary battery after being assembled is charged and discharged. Various conditions including, for example, an environment temperature, the number of times of charging and discharging (the number of cycles), and charging and discharging conditions, may be set as desired. A film is thereby formed on the surface of each of the positive electrode 21 and the negative electrode 22. This electrochemically stabilizes a state of the battery device 20. The secondary battery is thus completed.

According to the above-described secondary battery, the positive electrode 21 has the configuration similar to the configuration of the positive electrode 100. Accordingly, for the reasons described above, the electrical conductivity of the positive electrode active material layer 21B improves. This makes it possible to achieve a superior battery characteristic.

The secondary battery may include a lithium-ion secondary battery, in particular. This makes it possible to stably obtain a sufficient battery capacity through insertion and extraction of lithium. Accordingly, it is possible to achieve higher effects.

Other action and effects of the secondary battery are similar to those of the positive electrode 100.

The configuration of the secondary battery described above is appropriately modifiable as described below according to an embodiment. Note that any two or more of the following series of modification examples may be combined with each other.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves to suppress misalignment of the battery device 20 (winding displacement of each of the positive electrode 21, the negative electrode 22, and the separator 23). This suppresses swelling of the secondary battery even if a decomposition reaction of the electrolytic solution occurs. The polymer compound layer includes a polymer compound such as polyvinylidene difluoride. One reason for this is that polyvinylidene difluoride is superior in physical strength and is electrochemically stable.

Note that the porous film, the polymer compound layer, or both may include multiple insulating particles. One reason for this is that the insulating particles promote heat dissipation upon heat generation by the secondary battery, thus improving safety or heat resistance of the secondary battery. The insulating particles include any one or more of insulating materials including, without limitation, inorganic materials and resin materials. Specific examples of the inorganic materials include aluminum oxide, aluminum nitride, boehmite, silicon oxide, titanium oxide, magnesium oxide, and zirconium oxide. Specific examples of the resin materials include acrylic resin and styrene resin.

To fabricate the separator of the stacked type, a precursor solution including, without limitation, the polymer compound and a solvent is prepared, following which the precursor solution is applied on one of or each of the two opposed surfaces of the porous film. In this case, the insulating particles may be added to the precursor solution on an as-needed basis.

When the separator of the stacked type is used also, lithium is movable between the positive electrode 21 and the negative electrode 22, and similar effects are therefore achievable. In this case, in particular, the secondary battery improves in safety, as described above. Accordingly, it is possible to achieve higher effects.

The electrolytic solution, i.e., a liquid electrolyte, is used. However, although not specifically illustrated here, an electrolyte layer may be used. The electrolyte layer is a gel electrolyte.

In the battery device 20 including the electrolyte layer, the positive electrode 21 and the negative electrode 22 are opposed to each other with the separator 23 and the electrolyte layer interposed therebetween, and are wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that this prevents leakage of the electrolytic solution. The electrolytic solution has the configuration described above. The polymer compound includes, for example, polyvinylidene difluoride. To form the electrolyte layer, a precursor solution including, without limitation, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Applications (application examples) of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, and is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a battery cell, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery that is an electric power storage source may be utilized for using, for example, home appliances.

An application example of the secondary battery will now be described in detail. The configuration of the application example described below is merely an example, and is appropriately modifiable.

FIG. 4 illustrates a block configuration of a battery pack. The battery pack described here is a battery pack (what is called a soft pack) including one secondary battery, and is to be mounted on, for example, electronic equipment typified by a smartphone.

The battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.20 V±0.05 V. The overdischarge detection voltage is not particularly limited, and is specifically 2.40 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Charging and discharging currents are detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 12 and Comparative Examples 1 to 3

As described below, secondary batteries were fabricated and thereafter, the fabricated secondary batteries were each evaluated for a battery characteristic.

### [Fabrication of Secondary Battery]

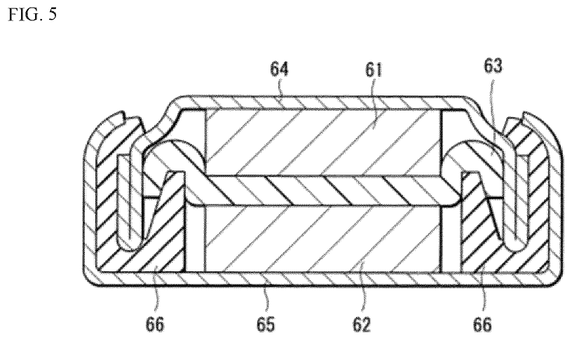

FIG. 5 illustrates a sectional configuration of a secondary battery for testing. The secondary battery for testing is a secondary battery (a lithium-ion secondary battery) of what is called a coin type.

The secondary battery included a test electrode 61, a counter electrode 62, a separator 63, an outer package cup 64, an outer package can 65, a gasket 66, and an electrolytic solution (not illustrated).

The test electrode 61 was contained in the outer package cup 64, and the counter electrode 62 was contained in the outer package can 65. The test electrode 61 and the counter electrode 62 were stacked on each other with the separator 63 interposed therebetween. The test electrode 61, the counter electrode 62, and the separator 63 were impregnated with the electrolytic solution. The outer package cup 64 and the outer package can 65 were crimped to each other with the gasket 66 interposed therebetween. The test electrode 61, the counter electrode 62, and the separator 63 were thus sealed in the outer package cup 64 and the outer package can 65.

The secondary battery of the coin type illustrated in FIG. 5 was fabricated by the following procedure.

### [Fabrication of Test Electrode]

To fabricate the test electrode 61, first, the carboxymethyl cellulose salt (thickener), the positive electrode conductor in powder form, and an aqueous solvent (pure water) were mixed with each other to obtain a first mixture liquid, following which the first mixture liquid was stirred (i.e., preliminary kneading was performed) using a planetary mixer.

As the carboxymethyl cellulose salt, sodium carboxymethyl cellulose (CMCNa) was used. Used as the positive electrode conductor were Ketjen black (KC, having a specific surface area of 800 m²/g) and acetylene black (AB, having a specific surface area of 133 m²/g), each of which is carbon black.

Thereafter, the positive electrode active material particles and an aqueous solvent (pure water) were added to the first mixture liquid to thereby obtain a second mixture liquid, following which the second mixture liquid was stirred (i.e., main kneading was performed) using the planetary mixer.

As the positive electrode active material particles, a lithium iron phosphoric acid compound (LiFePO₄ (LFP) in powder form (median diameter MD1: 1.0 μm; median diameter MD2: 9.0 μm) was used which is an olivine phosphoric acid compound.

Thereafter, an emulsion liquid of the positive electrode binder and an aqueous solvent (pure water) were added to the second mixture liquid, following which the second mixture liquid was stirred using the planetary mixer. A positive electrode mixture slurry including the positive electrode active material particles, the positive electrode binder, the positive electrode conductor, and the carboxymethyl cellulose salt was thereby prepared.

Used as the positive electrode binder was a copolymer of methyl acrylate and acrylonitrile (PAA), which is an acrylic acid ester polymer (a copolymer of the acrylic acid ester). In this case, a copolymerization amount of methyl acrylate was set to 50 wt %, and a copolymerization amount of acrylonitrile was set to 50 wt %.

In preparing the positive electrode mixture slurry, the solids concentration of each of the first mixture liquid and the second mixture liquid was set to 72% and the solids concentration of the positive electrode mixture slurry was set to 62%.

Thereafter, the positive electrode mixture slurry was applied on one of the two opposed surfaces of the positive electrode current collector (an aluminum foil having a thickness of 12 μm) using a coating apparatus, following which the positive electrode mixture slurry was dried to thereby form the positive electrode active material layer. In this case, an application amount of the positive electrode mixture slurry was set to 22 mg/cm². Thereafter, the positive electrode active material layer was compression-molded using a roll pressing machine. In this case, a volume density of the positive electrode active material layer was set to 2.1 g/cm³.

Lastly, the positive electrode current collector with the positive electrode active material layer formed thereon was punched into a disk shape having a diameter of 16.5 mm. The test electrode 61 was thereby fabricated.

After the test electrode 61 was fabricated, the content (wt %) of the positive electrode binder in the positive electrode active material layer 21B, the content (wt %) of the carboxymethyl cellulose salt in the positive electrode active material layer 21B, the content (wt %) of the positive electrode conductor in the positive electrode active material layer 21B, and the volume resistivity R (Ω·cm) were examined.

In this case, the content of the positive electrode binder in the positive electrode active material layer 21B was 3.0 wt %, and the content of the carboxymethyl cellulose salt in the positive electrode active material layer 21B was 1.0 wt %. Further, the content of the positive electrode conductor in the positive electrode active material layer 21B and the volume resistivity R were as listed in Table 1.

Note that a test electrode 61 for comparison was fabricated by a similar procedure except for using, as the positive electrode conductor, carbon nanotubes (CNT, having an average fiber length of 150 μm) instead of carbon black (Ketjen black). In Table 1, a symbol “*” before “CNT” indicates exceptional listing of carbon nanotubes under a “carbon black” column despite deviation from a category of carbon black.

### [Fabrication of Counter Electrode]

A lithium metal plate was punched into a disk shape having a diameter of 17 mm. The counter electrode 62 was thereby obtained.

### [Preparation of Electrolytic Solution]

The electrolyte salt (lithium hexafluorophosphate (LiPF₆)) was added to the solvent (ethylene carbonate as the cyclic carbonic acid ester and diethyl carbonate as the chain carbonic acid ester), following which the solvent was stirred. In this case, a mixture ratio (a weight ratio) between ethylene carbonate and diethyl carbonate in the solvent was set to 30:70, and the content of the electrolyte salt in the electrolytic solution was set to 1 mol/kg with respect to the solvent. The electrolytic solution was thereby prepared.

### [Assembly of Secondary Battery]

First, the test electrode 61 was placed into the outer package cup 64, and the counter electrode 62 was placed into the outer package can 65. Thereafter, the test electrode 61 placed in the outer package cup 64 and the counter electrode 62 placed in the outer package can 65 were stacked on each other, with the separator 63 (a fine porous polyethylene film having a thickness of 20 μm and a diameter of 17.5 mm) impregnated with the electrolytic solution being interposed between the test electrode 61 and the counter electrode 62. In this case, the positive electrode active material layer and the counter electrode 62 were opposed to each other with the separator 63 interposed therebetween. Thereafter, the outer package cup 64 and the outer package can 65 were crimped to each other with the gasket 66 interposed therebetween in a state where the test electrode 61 and the counter electrode 62 were stacked on each other with the separator 63 interposed therebetween. The test electrode 61 and the counter electrode 62 were thus sealed by the outer package cup 64 and the outer package can 65. As a result, the secondary battery was assembled. Lastly, the assembled secondary battery was left to stand (for a standing time of 10 hours).

The secondary battery was thus completed.

### [Evaluation of Battery Characteristic]

Evaluation was performed on electric resistance characteristic as the battery characteristic. The evaluation revealed the results presented in Table 1.

To evaluate the electric resistance characteristic, first, the secondary battery was charged in an ambient temperature environment (at a temperature of 23° C.) until a battery voltage reached 3.5 V.

Thereafter, the secondary battery was discharged with a current of 2.0 C in the same environment while a discharge capacity (mAh/g) was measured. Note that 2.0 C was a value of a current that caused a battery capacity (a theoretical capacity) to be completely discharged in 0.5 hours.

Lastly, a battery voltage (V) at which the discharge capacity reached 100 mAh/g was examined. An electrical state of the secondary battery as an index for evaluating the electric resistance characteristic was thus determined based on the battery voltage. Results of determination of the electrical state of the secondary battery were as listed in Table 1.

Specifically, when the battery voltage was 3.0 V or higher, the electrical state was determined to be “A” because the battery voltage was substantially retained with almost no decrease. When the battery voltage was 2.8 V or higher and less than 3.0 V, the electrical state was determined to be “B” because the battery voltage exhibited a decrease within an acceptable range without exhibiting an excessive decrease. When the battery voltage was less than 2.8 V, the electrical state was determined to be “C” because the battery voltage exhibited an excessive decrease.

TABLE 1

| | Positive electrode active | | | | | | | | |
|---|---|---|---|---|---|---|---|---|---|
| | material particle | | | Positive | | Positive electrode | | | |
| | Olivine | | | electrode binder | Thickener | conductor | | Volume | |
| | phosphoric acid | MD1 | MD2 | Acrylic acid | Carboxymethyl | Carbon | Content | resistivity | Result of |
| | compound | (μm) | (μm) | ester polymer | cellulose salt | black | (wt %) | R (Ω · cm) | determination |
| Comparative | LFP | 1.0 | 9.0 | PAA | CMCNa | KC | 0.2 | 115.4 | C |
| example 1 | | | | | | | | | |
| Example 1 | LFP | 1.0 | 9.0 | PAA | CMCNa | KC | 0.5 | 100.0 | A |
| Example 2 | LFP | 1.0 | 9.0 | PAA | CMCNa | KC | 1.5 | 60.8 | A |
| Example 3 | LFP | 1.0 | 9.0 | PAA | CMCNa | KC | 2.0 | 57.2 | A |
| Example 4 | LFP | 1.0 | 9.0 | PAA | CMCNa | KC | 2.5 | 67.8 | A |
| Example 5 | LFP | 1.0 | 9.0 | PAA | CMCNa | KC | 3.0 | 65.8 | A |
| Comparative | LFP | 1.0 | 9.0 | PAA | CMCNa | KC | 5.0 | 4.6 | C |
| example 2 | | | | | | | | | |
| Comparative | LFP | 1.0 | 9.0 | PAA | CMCNa | *CNT | 0.2 | 2.2 | C |
| example 3 | | | | | | | | | |
| Example 6 | LFP | 1.0 | 9.0 | PAA | CMCNa | AB | 1.0 | 10.0 | B |
| Example 7 | LFP | 1.0 | 9.0 | PAA | CMCNa | KC | 1.5 | 13.7 | A |
| Example 8 | LFP | 1.0 | 9.0 | PAA | CMCNa | KC | 1.0 | 24.8 | A |
| Example 9 | LFP | 1.0 | 9.0 | PAA | CMCNa | AB | 3.0 | 37.2 | B |
| Example 10 | LFP | 1.0 | 9.0 | PAA | CMCNa | AB | 2.0 | 70.6 | B |
| Example 11 | LFP | 1.0 | 9.0 | PAA | CMCNa | AB | 0.5 | 86.3 | B |
| Example 12 | LFP | 1.0 | 9.0 | PAA | CMCNa | AB | 0.5 | 93.7 | B |

As indicated in Table 1, the electric resistance characteristic varied depending on a physical property (the volume resistivity R) of the test electrode 61.

Specifically, when the volume resistivity R was greater than 100 Ω·cm (Comparative example 1) and when the volume resistivity R was less than 10 Ω·m (Comparative example 2), the electric resistance characteristic deteriorated due to an excessive decrease in battery voltage, even if carbon black was used as the positive electrode conductor.

Such a tendency of the electric resistance characteristic to deteriorate was also observed similarly when carbon nanotubes were used as the positive electrode conductor (Comparative example 3).

In contrast, when carbon black was used as the positive electrode conductor and the volume resistivity R was within the range from 10 Ω·cm to 100 Ω·cm both inclusive (Examples 1 to 12), the battery voltage exhibited a decrease within the acceptable range without exhibiting an excessive decrease, and the electric resistance characteristic thus improved.

In such a case (Examples 1 to 12), the electric resistance characteristic further improved when the carbon black was Ketjen black, in particular.

### Examples 13 to 18

Secondary batteries were fabricated by a procedure similar to that in Example 2 except that the content (wt %) of the positive electrode binder in the positive electrode active material layer 21B was changed as listed in Table 2, following which the secondary batteries were evaluated for their respective battery characteristics.

TABLE 2

| | Positive electrode active | | | Positive electrode | | | | | |
|---|---|---|---|---|---|---|---|---|---|
| | material particle | | | binder | | | | | |
| | Olivine | | | Acrylic | | Thickener | Positive electrode | Volume | |
| | phosphoric acid | MD1 | MD2 | acid ester | Content | Carboxymethyl | conductor | resistivity | Result of |
| | compound | (μm) | (μm) | polymer | (wt %) | cellulose salt | Carbon black | R (Ω · cm) | determination |
| Example 13 | LFP1 | 1.0 | 9.0 | PAA | 0.1 | CMCNa | KC | 81.3 | B |
| Example 14 | LFP1 | 1.0 | 9.0 | PAA | 0.5 | CMCNa | KC | 76.3 | A |
| Example 15 | LFP1 | 1.0 | 9.0 | PAA | 1.0 | CMCNa | KC | 67.9 | A |
| Example 16 | LFP1 | 1.0 | 9.0 | PAA | 2.0 | CMCNa | KC | 66.9 | A |
| Example 2 | LFP1 | 1.0 | 9.0 | PAA | 3.0 | CMCNa | KC | 60.8 | A |
| Example 17 | LFP1 | 1.0 | 9.0 | PAA | 4.0 | CMCNa | KC | 64.4 | A |
| Example 18 | LFP1 | 1.0 | 9.0 | PAA | 6.0 | CMCNa | KC | 83.0 | B |

As indicated in Table 2, results similar to those presented in Table 1 were obtained despite changes in the content of the positive electrode binder in the positive electrode active material layer 21B. In this case, when the content of the positive electrode binder in the positive electrode active material layer 21B was within the range from 0.5 wt % to 4.0 wt % both inclusive, in particular, the battery voltage was substantially retained with almost no decrease.

### Examples 19 to 23

Secondary batteries were fabricated by a procedure similar to that in Example 2 except that the content (wt %) of the carboxymethyl cellulose salt in the positive electrode active material layer 21B was changed as listed in Table 3, following which the secondary batteries were evaluated for their respective battery characteristics.

TABLE 3

| | Positive electrode active | | | | | | | | |
|---|---|---|---|---|---|---|---|---|---|
| | material particle | | | Positive electrode | | | | | |
| | Olivine | | | binder | Thickener | | Positive electrode | Volume | |
| | phosphoric acid | MD1 | MD2 | Acrylic acid ester | Carboxymethyl | Content | conductor | resistivity | Result of |
| | compound | (μm) | (μm) | polymer | cellulose salt | (wt %) | Carbon black | R (Ω · cm) | determination |
| Example 19 | LFP1 | 1.0 | 9.0 | PAA | CMCNa | 0.4 | KC | 44.7 | B |
| Example 20 | LFP1 | 1.0 | 9.0 | PAA | CMCNa | 0.6 | KC | 52.3 | A |
| Example 2 | LFP1 | 1.0 | 9.0 | PAA | CMCNa | 1.0 | KC | 60.8 | A |
| Example 21 | LFP1 | 1.0 | 9.0 | PAA | CMCNa | 1.5 | KC | 69.8 | A |
| Example 22 | LFP1 | 1.0 | 9.0 | PAA | CMCNa | 2.0 | KC | 74.4 | A |
| Example 23 | LFP1 | 1.0 | 9.0 | PAA | CMCNa | 2.2 | KC | 78.5 | B |

As indicated in Table 3, results similar to those presented in Table 1 were obtained despite changes in the content of the carboxymethyl cellulose salt in the positive electrode active material layer 21B. In this case, when the content of the carboxymethyl cellulose salt in the positive electrode active material layer 21B was within the range from 0.6 wt % to 2.0 wt % both inclusive, in particular, the battery voltage was substantially retained with almost no decrease.

### Examples 24 to 31

Secondary batteries were fabricated by a procedure similar to that in Example 2 except that the median diameters MD1 and MD2 were each changed as listed in Table 4, following which the secondary batteries were evaluated for their respective battery characteristics.

Here, not only the electric resistance characteristic but also a cyclability characteristic was evaluated as a battery characteristic. To evaluate the cyclability characteristic, first, the secondary battery was charged and discharged in an ambient temperature environment to thereby measure a discharge capacity (a first-cycle discharge capacity). Thereafter, the secondary battery was repeatedly charged and discharged in the same environment until a total number of cycles reached 100 to thereby measure the discharge capacity (a 100th-cycle discharge capacity). Lastly, a capacity retention rate as an index for evaluating the cyclability characteristic was calculated based on the following calculation expression: capacity retention rate (%)=(100th-cycle discharge capacity/first-cycle discharge capacity)×100.

Upon charging, the secondary battery was charged with a constant current of 0.1 C until a voltage reached 3.6 V, and was thereafter charged with a constant voltage of that value, 3.6 V, until a current reached 0.05 C. Upon discharging, the secondary battery was discharged with a constant current of 0.1 C until the voltage reached 2.0 V. Note that 0.1 C was a value of a current that caused the battery capacity (the theoretical capacity) to be completely discharged in 10 hours, and 0.05 C was a value of a current that caused the battery capacity to be completely discharged in 20 hours.

TABLE 4

| | Positive electrode active | | | | | | | | |
|---|---|---|---|---|---|---|---|---|---|
| | material particle | | | Positive electrode | | | | | |
| | Olivine | | | binder | Thickener | Positive electrode | Volume | | Capacity |
| | phosphoric acid | MD1 | MD2 | Acrylic acid ester | Carboxymethyl | conductor | resistivity | Result of | retention |
| | compound | (μm) | (μm) | polymer | cellulose salt | Carbon black | R (Ω · cm) | determination | rate (%) |
| Example 24 | LFP | 0.5 | 9.0 | PAA | CMCNa | KC | 57.4 | A | 97 |
| Example 2 | LFP | 1.0 | 9.0 | PAA | CMCNa | KC | 60.8 | A | 95 |
| Example 25 | LFP | 2.0 | 9.0 | PAA | CMCNa | KC | 63.0 | A | 91 |
| Example 26 | LFP | 1.0 | 2.0 | PAA | CMCNa | KC | 62.7 | A | 88 |
| Example 27 | LFP | 1.0 | 4.0 | PAA | CMCNa | KC | 55.3 | A | 96 |
| Example 28 | LFP | 1.0 | 10.0 | PAA | CMCNa | KC | 60.4 | A | 95 |
| Example 29 | LFP | 1.0 | 15.0 | PAA | CMCNa | KC | 68.8 | A | 96 |
| Example 30 | LFP | 1.0 | 20.0 | PAA | CMCNa | KC | 61.9 | A | 96 |
| Example 31 | LFP | 1.0 | 30.0 | PAA | CMCNa | KC | 70.8 | A | 85 |

As indicated in Table 4, results similar to those presented in Table 1 were obtained despite respective changes in the median diameters MD1 and MD2. In this case, when the median diameter MD1 was 1 μm or less and the median diameter MD2 was within the range from 4 μm to 20 μm both inclusive, in particular, the capacity retention rate increased while the battery voltage was substantially retained with almost no decrease, when the content of the carboxymethyl cellulose salt in the positive electrode active material layer 21B was within the range from 0.6 wt % to 2.0 wt % both inclusive.

The results presented in Tables 1 to 4 indicate that when: the positive electrode active material layer B included the positive electrode active material particles (the olivine phosphoric acid compound), the positive electrode binder (the acrylic acid ester polymer), the positive electrode conductor (carbon black), and the carboxymethyl cellulose salt; and the positive electrode active material layer 100B had the volume resistivity R within the range from 10 Ω·cm to 100 Ω·cm both inclusive, the electric resistance characteristic improved. Accordingly, the secondary battery achieved a superior battery characteristic.

Although the present technology has been described above with reference to one or more embodiments including Examples, the configuration of the present technology is not limited to the configurations described with reference to the one or more embodiments including Examples above, and is therefore modifiable in a variety of ways.

Specifically, the description has been given of the case where the secondary battery has a battery structure of the cylindrical type or the coin type. However, the battery structure of the secondary battery is not particularly limited, and the secondary battery may thus have a battery structure of, for example, a laminated-film type, a prismatic type, or a button type.

Further, the description has been given of the case where the battery device has a device structure of a wound type; however, the device structure of the battery device is not particularly limited, and the battery device may thus have a device structure of, for example, a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve other effects.

Note that the present technology may have any of the following configurations according to an embodiment.

<1>

A secondary battery including:
a positive electrode including a positive electrode active material layer;
a negative electrode; and
an electrolytic solution, in which
the positive electrode active material layer includes positive electrode active material particles, a positive electrode binder, a positive electrode conductor, and a carboxymethyl cellulose salt,
the positive electrode active material particles include a phosphoric acid compound having an olivine crystal structure,
the positive electrode binder includes an acrylic acid ester polymer,
the positive electrode conductor includes carbon black, and
the positive electrode active material layer has a volume resistivity of greater than or equal to 10 ohm-centimeters and less than or equal to 100 ohm-centimeters.
   <2>

The secondary battery according to <1>, in which the carbon black includes Ketjen black.

<3>

The secondary battery according to <1> or <2>, in which a content of the positive electrode conductor in the positive electrode active material layer is greater than or equal to 0.5 weight percent and less than or equal to 3.0 weight percent.

<4>

The secondary battery according to any one of <1> to <3>, in which the phosphoric acid compound includes lithium and iron as constituent elements.

<5>

The secondary battery according to any one of <1> to <4>, in which the acrylic acid ester polymer includes a copolymer of an acrylic acid ester and acrylonitrile.

<6>

The secondary battery according to any one of <1> to <5>, in which a content of the positive electrode binder in the positive electrode active material layer is greater than or equal to 0.5 weight percent and less than or equal to 4.0 weight percent.

<7>

The secondary battery according to any one of <1> to <6>, in which the carboxymethyl cellulose salt includes sodium carboxymethyl cellulose.

<8>

The secondary battery according to any one of <1> to <7>, in which a content of the carboxymethyl cellulose salt in the positive electrode active material layer is greater than or equal to 0.6 weight percent and less than or equal to 2.0 weight percent.

<9>

The secondary battery according to any one of <1> to <8>, in which
the positive electrode active material particles include secondary particles that each include an aggregate of primary particles,
the primary particles have a median diameter of less than or equal to 1 micrometer, and
the positive electrode active material particles that include the secondary particles have a median diameter of greater than or equal to 4 micrometers and less than or equal to 20 micrometers.
   <10>

The secondary battery according to any one of <1> to <9>, in which the secondary battery includes a lithium-ion secondary battery.

<11>

A positive electrode for a secondary battery, the positive electrode including
a positive electrode active material layer, in which
the positive electrode active material layer includes positive electrode active material particles, a positive electrode binder, a positive electrode conductor, and a carboxymethyl cellulose salt,
the positive electrode active material particles include a phosphoric acid compound having an olivine crystal structure,
the positive electrode binder includes an acrylic acid ester polymer,
the positive electrode conductor includes carbon black, and
the positive electrode active material layer has a volume resistivity of greater than or equal to 10 ohm-centimeters and less than or equal to 100 ohm-centimeters.

### DESCRIPTION OF REFERENCE NUMERALS

20 battery device
21 positive electrode
21B positive electrode active material layer
22 negative electrode

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer;
a negative electrode; and
an electrolytic solution, wherein
the positive electrode active material layer includes positive electrode active material particles, a positive electrode binder, a positive electrode conductor, and a carboxymethyl cellulose salt,
the positive electrode active material particles include a phosphoric acid compound having an olivine crystal structure,
the positive electrode binder includes an acrylic acid ester polymer,
the positive electrode conductor includes carbon black, and
the positive electrode active material layer has a volume resistivity of greater than or equal to 10 ohm-centimeters and less than or equal to 100 ohm-centimeters.

2. The secondary battery according to claim 1, wherein the carbon black includes Ketjen black.

3. The secondary battery according to claim 1, wherein a content of the positive electrode conductor in the positive electrode active material layer is greater than or equal to 0.5 weight percent and less than or equal to 3.0 weight percent.

4. The secondary battery according to claim 1, wherein the phosphoric acid compound includes lithium and iron as constituent elements.

5. The secondary battery according to claim 1, wherein the acrylic acid ester polymer includes a copolymer of an acrylic acid ester and acrylonitrile.

6. The secondary battery according to claim 1, wherein a content of the positive electrode binder in the positive electrode active material layer is greater than or equal to 0.5 weight percent and less than or equal to 4.0 weight percent.

7. The secondary battery according to claim 1, wherein the carboxymethyl cellulose salt includes sodium carboxymethyl cellulose.

8. The secondary battery according to claim 1, wherein a content of the carboxymethyl cellulose salt in the positive electrode active material layer is greater than or equal to 0.6 weight percent and less than or equal to 2.0 weight percent.

9. The secondary battery according to claim 1, wherein
the positive electrode active material particles comprise secondary particles that each include an aggregate of primary particles,
the primary particles have a median diameter of less than or equal to 1 micrometer, and
the positive electrode active material particles that comprise the secondary particles have a median diameter of greater than or equal to 4 micrometers and less than or equal to 20 micrometers.

10. The secondary battery according to claim 1, wherein the secondary battery comprises a lithium-ion secondary battery.

11. A positive electrode for a secondary battery, the positive electrode comprising
a positive electrode active material layer, wherein
the positive electrode active material layer includes positive electrode active material particles, a positive electrode binder, a positive electrode conductor, and a carboxymethyl cellulose salt,
the positive electrode active material particles include a phosphoric acid compound having an olivine crystal structure,
the positive electrode binder includes an acrylic acid ester polymer,
the positive electrode conductor includes carbon black, and
the positive electrode active material layer has a volume resistivity of greater than or equal to 10 ohm-centimeters and less than or equal to 100 ohm-centimeters.
